(19) United States
(12) Patent Application Publication
(10) Pub. No.: US 2026/0232510 A1
(43) Pub. Date: Aug. 13, 2026

(54) SHRAPNEL RHYTHMIC MOVEMENT MECHANISM AND RHYTHMIC FURNITURE

(71) Applicant: SHENZHEN FAR EXCEEDS SMART LIFE CO., LTD, Shenzhen, Guangdong (CN)

(72) Inventor: Shuhan CAO, Shenzhen, Guangdong (CN)

(21) Appl. No.: 18/878,171

(22) PCT Filed: Mar. 14, 2024
(86) PCT No.: PCT/CN2024/081663

§ 371 Date: Dec. 23, 2024

(30) Foreign Application Priority Data
Nov. 20, 2023 (CN) 202311554205.X
Mar. 8, 2024 (CN) 202420477206.2

(51) Int. Cl. A61H 1/00; A61H 23/02

(52) U.S. Cl. CPC A61H 1/005; A61H 1/001; A61H 23/0254; A61H 2201/0149; A61H 2201/1215; A61H 2201/149

(57) ABSTRACT

A shrapnel rhythmic movement mechanism, which includes a first frame body; a second frame body, where the second frame body and the first frame body are movable relative to each other; a driving mechanism, where a power output of the driving mechanism is in transmission connection with the second frame body, the driving mechanism is configured to drive the second frame body to reciprocate relative to the first frame body; a shrapnel direction structure provided vertically, where an end of the shrapnel direction structure is connected to the first frame body, another end of the shrapnel direction structure is connected to the second frame body, the shrapnel direction structure moves following the second frame body and is elastically deformable, and the shrapnel direction structure is deformed in a same direction as a movement of the second frame body.

### CROSS-REFERENCE TO RELATED APPLICATIONS

This application is a national stage entry under 37 U.S.C. § 371 of International Application No. PCT/CN 2024/081663, filed on Mar. 14, 2024, and claims priority to Chinese Patent Application No. 202311554205.X, filed on Nov. 20, 2023, and Chinese Patent Application No. 202420477206.2, filed on Mar. 8, 2023, the entire disclosures of which are incorporated herein by reference.

### TECHNICAL FIELD

The present application relates to the technical field related to furniture, and in particular relates to a shrapnel rhythmic movement mechanism and rhythmic furniture.

### BACKGROUND

As people's living conditions continue to improve, a variety of rhythmic chairs, rhythmic beds and other furniture are rapidly developed. The frame of the rhythmic furniture realizes reciprocation movement, so as to implement rhythmic massage to the user.

In the related art, with respect to the frame of the rhythmic furniture, referring to Patent application No. CN219515773U, which discloses a vibration device and furniture, in which a swinging frame moves back and forth relative to a fixed frame, a guiding structure between the swinging frame and the fixed frame mainly adopts a swinging member, a universal joint assembly, and a steel wire rope for connection and cooperation in order to limit the relative position and movement direction of the fixed frame and the swinging frame. The above guide structure is complicated and cost much, and the wire rope is not only less stable, but also has a shorter life span.

### SUMMARY

There is provided a shrapnel rhythmic movement mechanism according to embodiments of the present application. The technical solution is as below:

According to a first aspect of embodiments of the present application, there is provided a shrapnel rhythmic movement mechanism, which includes:
a first frame body;
a second frame body, where the second frame body and the first frame body are movable relative to each other;
a driving mechanism, where a power output of the driving mechanism is in transmission connection with the second frame body, the driving mechanism is configured to drive the second frame body to reciprocate relative to the first frame body;
a shrapnel direction structure provided vertically, where an end of the shrapnel direction structure is connected to the first frame body, another end of the shrapnel direction structure is connected to the second frame body, the shrapnel direction structure moves following the second frame body and is elastically deformable, and the shrapnel direction structure is deformed in a same direction as a movement of the second frame body.

According to a second aspect of embodiments of the present application, there is provided a rhythmic furniture, which includes the shrapnel rhythmic movement mechanism as mentioned above.

### BRIEF DESCRIPTION OF THE DRAWINGS

In order to more clearly illustrate the technical solutions in the present application or the related art, the following will briefly introduce the accompanying drawings that need to be used in the description of the embodiments or the related art, and it will be obvious that the accompanying drawings in the following description are some of the embodiments of the present application, and for those skilled in the art, other accompanying drawings can be obtained based on these drawings without any creative labor.

FIG. 1 is a schematic structural diagram of a first view of one embodiment of a first frame body, a second frame body, a driving mechanism and a shrapnel direction structure of a shrapnel rhythmic movement mechanism provided by the present application.

FIG. 2 is a decomposition schematic diagram of FIG. 1.

FIG. 3 is a schematic structural diagram of a second view of one embodiment of the first frame body, the second frame body, the driving mechanism, and the shrapnel direction structure of the shrapnel rhythmic movement mechanism provided by the present application.

FIG. 4 is a three-dimensional schematic diagram of another embodiment of the shrapnel rhythmic movement mechanism provided by the present application.

FIG. 5 is a right view of another embodiment of the shrapnel rhythmic movement mechanism provided by the present application.

FIG. 6 is a schematic diagram of an assembly structure of a shrapnel direction structure and a spacing structure provided by the present application.

FIG. 7 is a decomposition schematic diagram of FIG. 6.

FIG. 8 is a schematic structural diagram of a driving mechanism provided by the present application.

FIG. 9 is a decomposition schematic diagram of FIG. 8.

### DETAILED DESCRIPTION OF THE EMBODIMENTS

In order to make the objects, technical solutions and advantages of the present application clearer, the technical solutions in the present application will be described clearly and completely in the following in conjunction with the accompanying drawings in the present application, and it is obvious that the described embodiments are part of the embodiments of the present application and not all of the embodiments. Based on the embodiments in the present application, all other embodiments obtained by those skilled in the art without making creative labor fall within the scope of the present application.

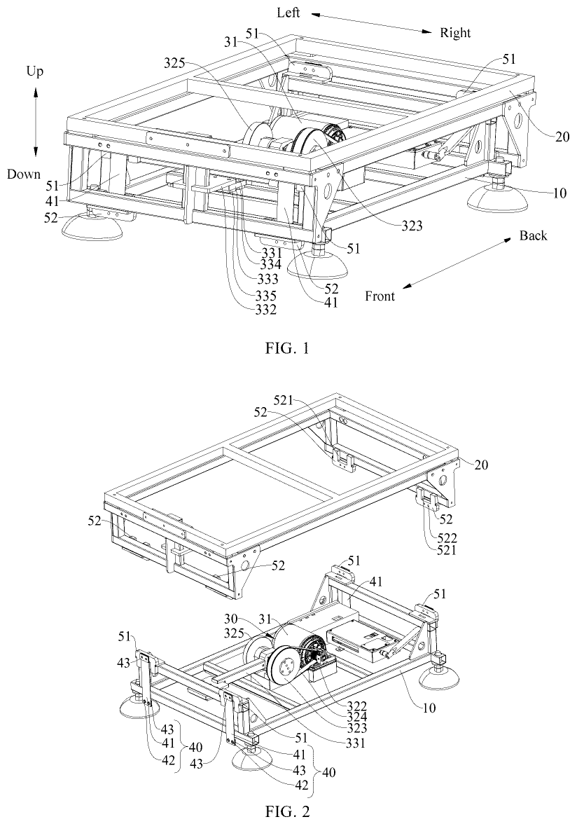

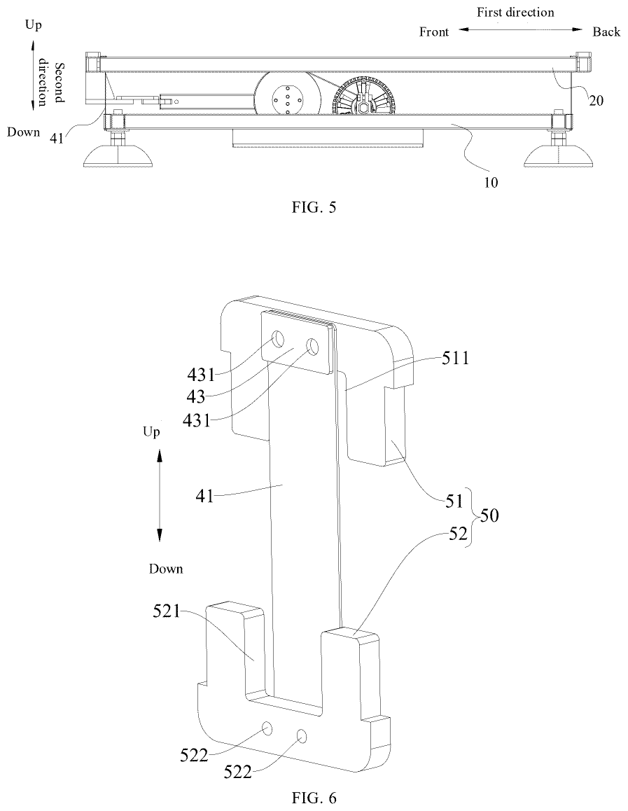

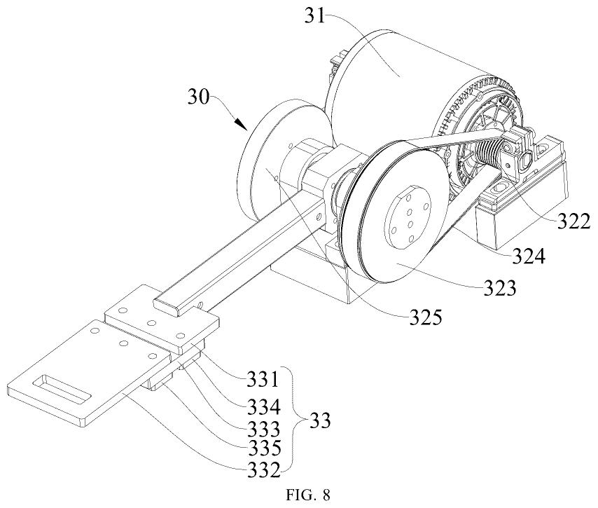

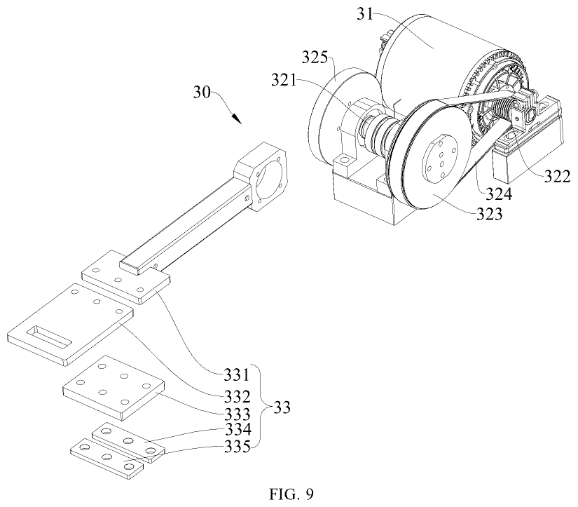

The shrapnel rhythmic movement mechanism and rhythmic furniture of the present application are described below in conjunction with FIG. 1-FIG. 9, the rhythmic furniture includes the above shrapnel rhythmic movement mechanism. It should be noted that regarding the type of the above rhythmic furniture, the rhythmic furniture may be a rhythmic chair, a rhythmic bed, etc., and in the embodiment of the present application, the rhythmic furniture is a rhythmic chair as being described.

Referring to FIGS. 1 to 7, a shrapnel rhythmic movement mechanism provided by the present application includes a first frame body 10, a second frame body 20, a driving mechanism 30, and a shrapnel direction structure 40.

Specifically, the second frame body 20 and the first frame body 10 can move back and forth relative to each other, the power output of the driving mechanism 30 is in transmission connection with the second frame body 20, and the driving mechanism 30 drives the second frame body 20 to reciprocate relative to the first frame body 10. The shrapnel direction structure 40 is vertically provided, and an end of the shrapnel direction structure 40 is connected to the first frame body 10, and another end of the shrapnel direction structure 40 is connected to the second frame body 20. The shrapnel direction structure 40 follows the second frame body 20 and can be elastically deformed, and the shrapnel direction structure 40 is deformed in a same direction as a 3 movement of the second frame body 20.

In the shrapnel rhythmic movement mechanism provided by the present application, when the driving mechanism 30 drives the second frame body 20 to move relative to the first frame body 10, the shrapnel direction structure 40 can follow the movement direction of the second frame body 20 to undergo elastic deformation, and the shrapnel direction structure 40 itself limits the movement direction of the second frame body 20, which helps to prevent the second frame body 20 from deviating from the movement direction, i.e. preventing the second frame body 20 from deviating from the movement direction and shaking, thereby improving the stability of the shrapnel rhythmic movement mechanism in the rhythm and improving the comfort of the user, and the structure is simple, the cost is low, and the service life is long.

It is to be noted that the carrier body for carrying the user is mounted on the second frame body 20, which may be a sofa or a bed, and is fixed to the second frame body 20 by screws.

The first frame body 10, the second frame body 20 and the shrapnel direction structure 40 have two ways of cooperation, the first way is that an upper end of the shrapnel direction structure 40 is connected to the first frame body 10, and a lower end of the shrapnel direction structure 40 is connected to the second frame body 20; in this way, the second frame body 20 is equivalent to being suspended from the first frame body 10 by the shrapnel direction structure 40, which is conducive to avoiding the second frame body deviating from the movement direction, that is, to preventing the second frame body frame from shaking and deviating from the movement direction, thereby improving the stability of the shrapnel rhythmic movement mechanism in the rhythm, and improving the comfort of the user. The structure is simple, the cost is low, and the service life is long. The second way is that the lower end of the shrapnel direction structure 40 is connected to the first frame body 10, and the upper end of the shrapnel direction structure 40 is connected to the second frame 20, the second frame body 20 is equivalent to being lifted above the first frame body 10 by the shrapnel direction structure 40. Lifting the second frame body 20 improves the bearing and supporting effect, which can play a buffering role during the movement of the second frame body, realizing a regular rhythmic massage effect, and can help lift the second frame body and maintain its stability, protect the relevant parts from damage, and improve the user's sense of comfort.

It is to be understood that with reference to FIGS. 1, 2, 6, and 7, in this embodiment, the elastic direction structure 40 includes an elastic plate 41, an upper end of the elastic plate 41 is connected to the first frame body 10, and a lower end of the elastic plate 41 is connected to the second frame body 20. When the second frame body 20 and the first frame body 10 move relative to each other, a direction of the force exerted on the elastic plate 41 by the second frame body 20 is mutually perpendicular with a plate surface of the elastic plate 41. With the above structure, when the second frame body 20 moves, the force is dispersed and absorbed by the own bending elasticity of the elastic plate 41 to limit the movement direction of the second frame body 20. Compared with the wire rope of the related art, the elastic plate 41, due to its planar form and better structural stability, can prevent the second frame body 20 from deviating from the movement direction, thereby improving the stability of the shrapnel rhythmic movement mechanism in the rhythm, and improving the comfort of the user.

It should be noted that, in this embodiment, since the second frame body 20 and the first frame body 10 move backward and forward relative to each other in the spatial direction, and the second frame body 20 is covered on the first frame body 10, thus the elastic plate 41 is provided vertically.

Specifically, with reference to FIGS. 1, 2, 6 and 7, in some embodiments of the present application, there also is a spacing structure 50, the spacing structure 50 is configured to make the upper end of the elastic plate 41 and the first frame body 10 spaced apart and to make the lower end of the elastic plate 41 and the second frame body 20 spaced apart. Through the above structure, when the second frame body 20 moves relative to the first frame body 10, the spacing structure 50 is provided, so that during the elastic deformation of the elastic plate 41, it is beneficial to avoid the elastic plate 41 from contacting or colliding with the first frame body 10 and the second frame body 20, thereby reducing noise and improving the sense of comfort during use.

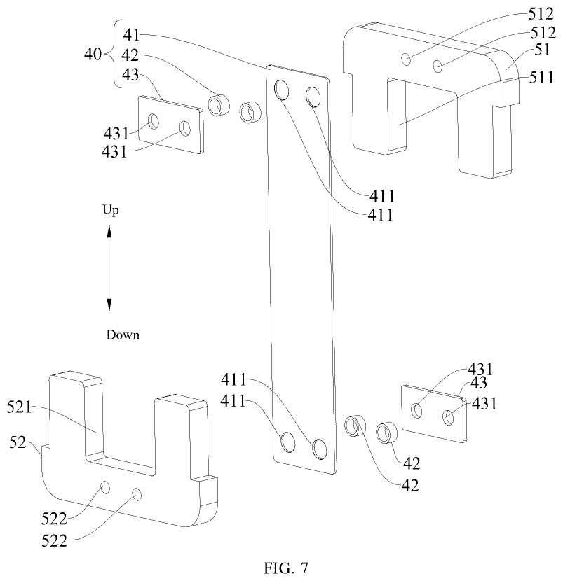

Specifically, with reference to FIG. 1, FIG. 2, FIG. 6, and FIG. 7, in some embodiments of the present application, the spacing structure 50 includes: a first partition 51 and a second partition 52, the first partition 51 is provided between the upper end of the elastic plate 41 and the first frame body 10, the upper end of the first partition 51 is connected to the first frame body 10, another end of the first partition 51 is connected to the upper end of the elastic plate 41, and the first partition 51 is provided with a first concave position adapted to a width of the elastic plate 41. A second partition 52 is provided between a lower end of the elastic plate 41 and the second frame body 20, an end of the second partition 52 is connected to the second frame body 20, and another end of the second partition 52 is connected to the lower end of the elastic plate 41, and the second partition 52 is provided with a second concave position 521 adapted to a width of the elastic plate 41. The first partition 51 has a thickness that is equal to or less than a spacing between a plate surface of the elastic plate 41 facing the first frame body 10 and the first frame body 10, and the second partition 52 has a thickness equal to or less than the spacing between a plate surface of the elastic plate 41 facing the second frame body 20 and the second frame body 20.

Through the above structure, the upper end of the elastic plate 41 is connected to the first frame body 10 through the first partition 51, and the lower end of the elastic plate 41 is connected to the second frame body 20 through the second partition 52, thereby further avoiding direct contact of the elastic plate 41 with the first frame body 10 and the second frame body 20. The first partition 51 is provided with a first concave position 511, and the second partition 52 is provided with a second concave position 521, so that during elastic deformation, the first concave position 511 is provided in the first partition 51 and the second concave position 521 is provided in the second partition 52. During elastic deformation, the first concave position 511 and the second concave position 521 can provide the elastic plate 41 with deformation space for avoidance and guiding deformation of the elastic plate 41 and protection of the elastic plate 41. The above structure is conducive to reducing the noise and improving the comfort of the use, and thus making the structure more reasonable.

It should be noted that for the thickness of the first partition 51 and the second partition 52, it should be ensure that the elastic plate 41 avoids contacting and colliding with the first frame body 10 and the second frame body 20 during deformation.

Specifically, with reference to FIGS. 2, 6 and 7, in the embodiment of the present application, the upper end of the elastic plate 41 is detachably connected to the first partition plate 51, and the lower end of the elastic plate 41 is detachably connected to the second partition plate 52, so as to facilitate disassembly and maintenance.

It is to be noted that the first partition 51 and the second partition 52 are shaped like a letter N, of course, the first partition 51 and the second partition 52 may also be shaped like a letter V, etc. The first frame body 10 is welded with a first welding plate, and a side wall of the first partition 51 is welded with the first welding plate. Of course, a side wall of the first partition 51 may also be detachably connected to the first welding plate by means of a snap-fit, a bolted-fit, etc. The second frame body 20 is welded with a second welding plate, a side wall of the second partition 52 is welded with the second welding plate. Of course, a side wall of the second partition 52 is detachably connected to the second welding plate by means of a snap-fit, a bolted-fit, etc., which is not limited herein.

Specifically, referring to FIGS. 2, 6, and 7, in this embodiment, the upper and lower ends of the elastic plate 41 are provided with connection through-holes 411, the first partition plate 51 is provided with a first mounting through-hole 512, and the second partition plate 52 is provided with a second mounting through-hole 522. The connection through-hole 411 at the upper end of the elastic plate 41 is correspondingly fitted with the first mounting through-hole 512, and the connection through-hole 411 at the lower end of the elastic plate 41 is correspondingly fitted with the second mounting through-hole 522. It can be understood that the connection through-hole 411 and the first mounting through-hole 512 are threaded through the first bolt and screwed to the first nut, and the connection through-hole 411 and the second mounting through-hole 522 are threaded through the second bolt and screwed to the second nut, to make the elastic plate 41 configured to be removable. The structure is simple and is easy to be manufactured and maintained. Of course, in some embodiments, the elastic plate 41 may also be detachably connected by other means, such as a snap-fit structure, or fixedly connected by welding, which is not limited herein.

Specifically, with reference to FIGS. 2, 6, and 7, in some embodiments of the present application, the shrapnel direction structure 40 further includes a plurality of washers 42, the washers fit one by one with the connection through-holes 411 in the elastic plate 41. It will be appreciated that the bolts are threaded through the washers 42 within the connection through-holes 411 and screwed to the nuts, the structure is simple to minimize friction on the elastic plate 41 and to improve the stability of the connection.

It is to be noted that each group of the shrapnel direction structure 40 has four washers 42, which are set according to the number of the connection through-holes 411.

Specifically, with reference to FIGS. 2, 6 and 7, in some embodiments of the present application, the shrapnel direction structure 40 further includes two pressure plates 43, the two pressure plates 43 are located at the upper and lower ends of the elastic plate 41, the pressure plate 43 is covered on a side of the washer 42, and the pressure plate 43 is provided with a mating through-hole 431 that is in communication with a hollow place of the washer 42. Since the pressure plate 43 is covered on the washer 42, and when installation and the elastic plate 41 deforms, the stability of the elastic plate 41 can be improved.

It should be noted that the elastic plate 41 is made of a steel material. Of course, in some embodiments, the shrapnel direction structure 40 may also be provided as a tension spring, torsion spring, or elastic column, etc., which are set according to the specific structure and are not limited herein.

It is understood that, referring to FIGS. 1, 2, and 3, in some embodiments of the present application, there are a plurality of groups of the shrapnel direction structures 40, some groups of shrapnel direction structures 40 are located at the front side of the first frame body 10 and the second frame body 20, and other groups of shrapnel direction structures 40 are located at the back side of the first frame body 10 and the second frame body 20, to improve the stability of the relative movement of the second frame body 20 and the first frame body 10.

Specifically, with reference to FIG. 1, in this embodiment, there are four groups of the shrapnel direction structures 40, and there are four groups of the spacing structures 50 correspondingly, which are the same as the number of shrapnel direction structures 40. It can be understood that there are two groups of shrapnel direction structures 40 on each of the front and back sides of the first frame body 10 and the second frame body 20, to further improve the stability of movement.

Of course, it is not limited to four groups of the shrapnel direction structures 40, and in some embodiments, it may also be one group, two groups, three groups or more of the shrapnel direction structures 40, for example, a group of shrapnel direction structures 40 is provided at the front and back sides of the first frame body 10 and the second frame body 20 that are opposite to each other. A group of shrapnel direction structures 40 is provided at the front sides of the first frame body 10 and the second frame body 20, and a group of shrapnel direction structures 40 is provided at the back sides of the first frame body 10 and the second frame body 20, or three groups of shrapnel direction structures 40 are provided on each of the opposite front and back sides of the first frame body 10 and the second frame body 20, or, in some cases, one group of shrapnel direction structures 40 are provided on the opposite front or back sides of the first frame body 10 and the second frame body 20 when there is one group of the shrapnel direction structures 40, which is not limited herein.

It is to be understood that with reference to FIGS. 1 to 3 and FIGS. 8 and 9, in some embodiments of the present application, the driving mechanism 30 includes a driving motor 31 provided in the first frame body 10, a transmission assembly 32 with an end in transmission connection with an output shaft of the driving motor 31, and a reciprocation movement unit 33 with an end of the reciprocation movement unit 33 that is in eccentrical transmission connection with another end of the transmission assembly 32 and another end that is in eccentrical transmission connection with the second frame body 20. With the above structure, when the driving motor 31 operates, the second frame body 20 reciprocates relative to the first frame body 10 through the eccentric transmission between the transmission assembly 32 and the reciprocation movement unit 33, and the eccentric setting is conducive to adjusting the pressure, controlling the vibration, and realizing the mechanical transmission.

Specifically, with reference to FIGS. 1 to 3 and FIGS. 8 and 9, in some embodiments of the present application, the transmission assembly 32 includes an eccentric shaft 321, a driving pulley 322, a following pulley 323 and a transmission belt 324. The eccentric shaft 321 is rotatably provided in the first frame body 10, and the reciprocation movement unit 33 is in transmission connection with the eccentric shaft 321. The driving pulley 322 is in transmission connection with the driving motor 31, the following pulley 323 is socketed to the eccentric shaft 321, and the transmission belt 324 is wrapped around the driving pulley 322 and the following pulley 323. A center line of rotation of some structures where the reciprocation movement unit 33 cooperates with the eccentric shaft 321 is non-overlapped with a center line of rotation of some structures where the following pulley 323 cooperates with the eccentric shaft 321. An end of the eccentric shaft 321 is provided with an inertia wheel 325 away from the following pulley 323. With the above structure, the pulley transmission has a certain degree of elasticity, which can reduce the shock and vibration in the mechanical transmission, and can provide a simple, flexible and economical power transmission method, which makes the shrapnel rhythmic movement mechanism more stable when it moves back and forth; secondly, the inertia wheel 325 can smooth the output torque of the driving motor 31, adjust the rotational speed response, provide additional energy output, and enhance the stability of the transmission.

Of course, in some embodiments, the transmission assembly 32 may also be a sprocket drive, etc., which is not limited herein.

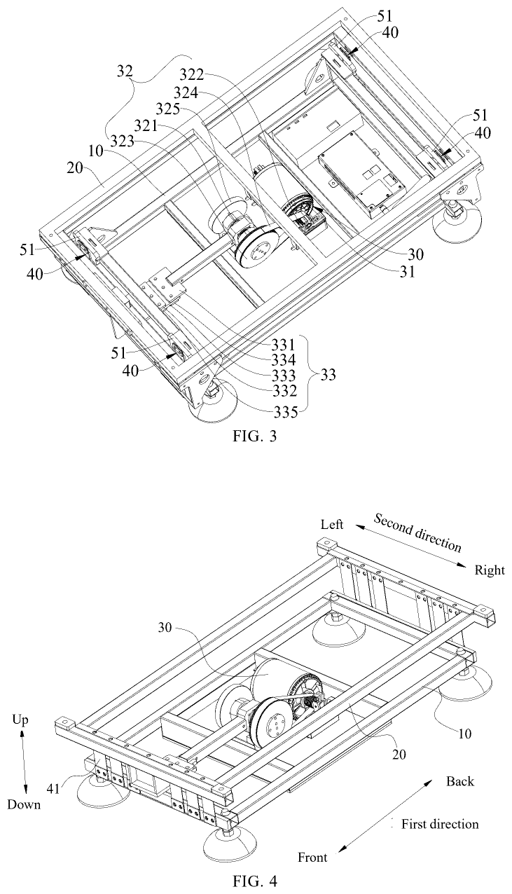

Specifically, with reference to FIGS. 3, 8, and 9, in an embodiment of the present application, the reciprocation movement unit 33 includes a first reciprocation plate 331, a second reciprocation plate 332 and a deformation plate 333. The first reciprocation plate 331 is connected to the eccentric shaft 321, the second reciprocation plate 332 is connected to the second frame body 20, an end of the deformation plate 333 is connected to the first reciprocation plate 331, and another end of the deformation plate 333 is connected to the second reciprocation plate 332, and there is a gap between the two opposite ends of the first reciprocation plate 331 and the second reciprocation plate 332. With the above structure, when the eccentric shaft 321 is driven eccentrically, at this time, the first reciprocation plate 331 has up and down amplitude oscillations while moving back and forth, therefore, in the process of transmission of the first reciprocation plate 331 to the second reciprocation plate 332, since the deformation plate 333 is provided between the first reciprocation plate 331 and the second reciprocation plate 332, the deformation plate 333 adapts to the up and down amplitude oscillations of the first reciprocation plate 331 through the deformation of the deformation plate 333, in order to avoid the up and down amplitude oscillation when the power is transmitted to the second reciprocation plate 332, so that the second reciprocation plate 332 can more smoothly drive the second frame body 20 to move relative to the first frame body 10, the transmission is smooth, and is conducive to reducing the noise, and the structure is simple, and the manufacturing cost is relatively low.

Specifically, with reference to FIGS. 3, 8, and 9, in an embodiment of the present application, the reciprocation movement unit 33 further includes a first pad 334 and a second pad 335. There is a gap between the first pad 334 and the second pad 335, the first pad 334 corresponds to the first reciprocation plate 331, the second pad 335 corresponds to the second reciprocation plate 332, and an end of the deformation plate 333 is clamped between the first reciprocation plate 331 and the first pad 334, and another end of the deformation plate 333 is clamped between the second reciprocation plate 332 and the second pad 335, which can further improve the assembly stability and transmission performance of the deformation plate 333.

It is to be noted that the gap between the first pad 334 and the second pad 335 is equal to the gap between the reciprocation plate and the second reciprocation plate 332 at their opposite ends, which is conducive to making the deformation amplitude of the deformation plate 333 consistent in the forward and backward movement, and to maintain the stability. The deformation plate 333 is a rubber plate, and the first reciprocation plate 331 and the second reciprocation plate 332 are detachably connected to the rubber plate by means of bolts or the like. Of course, the deformation plate 333 can also be a thinner steel plate, which can help ensure that the second reciprocation plate 332 only moves forward and backward without up and down amplitude oscillation during movement, which is not limited herein. The first reciprocation plate 331 and the second reciprocation plate 332 can be formed by a plurality of spliced plates that can be connected detachably. In some embodiments, the first reciprocation plate 331 and the second reciprocation plate 332 can also be a plate body or a column body, which is not limited herein.

Finally, it should be noted that the above embodiments are only used to illustrate, not to limit, the technical solutions of the present application; although the present application has been described in detail with reference to the foregoing embodiments, those skilled in the art should understand that it is still possible to make modifications to the technical solutions described in the foregoing embodiments, or to make equivalent substitutions for some of the technical features therein; and such modifications or substitutions do not make the corresponding technical solutions deviate from the essence of the various embodiments of the present application. These modifications or substitutions do not detach the essence of the technical solutions from the spirit and scope of the technical solutions of the embodiments of the present application.

1. A shrapnel rhythmic movement mechanism, comprising:
a first frame body
a second frame body wherein the second frame body and the first frame body are movable relative to each other;
a driving mechanism wherein a power output of the driving mechanism is in transmission connection with the second frame body the driving mechanism is configured to drive the second frame body to reciprocate relative to the first frame body; and
a shrapnel direction structure provided vertically, wherein an end of the shrapnel direction structure is connected to the first frame body, another end of the shrapnel direction structure is connected to the second frame body, the shrapnel direction structure moves following the second frame body and is elastically deformable, and the shrapnel direction structure is deformed in a same direction as a movement of the second frame body.

2. The shrapnel rhythmic movement mechanism according to claim 1, wherein an upper end of the shrapnel direction structure is connected to the first frame body, and a lower end of the shrapnel direction structure is connected to the second frame body.

3. The shrapnel rhythmic movement mechanism according to claim 1, wherein a lower end of the shrapnel direction structure is connected to the first frame body, and an upper end of the shrapnel direction structure is connected to the second frame body.

4. The shrapnel rhythmic movement mechanism according to claim 1, wherein a plurality of groups of shrapnel direction structures are provided, some groups of the plurality of groups of shrapnel direction structures are located on a side where the first frame body and the second frame body cooperate with each other, and other groups of the plurality of groups of shrapnel direction structures are located on another side where the first frame body and the second frame body cooperate with each other.

5. The shrapnel rhythmic movement mechanism according to claim 1, wherein the driving mechanism comprises:
a driving motor provided in the first frame body;
a transmission assembly, with an end being in transmission connection with an output shaft of the driving motor; and
a reciprocation movement unit, with an end being in eccentrical transmission connection with another end of the transmission assembly and another end being connected to the second frame body.

6. The shrapnel rhythmic movement mechanism according to claim 5, wherein the transmission assembly comprises:
an eccentric shaft rotatably provided in the first frame body, wherein the reciprocation movement unit is in transmission connection with the eccentric shaft;
a driving pulley, in transmission connection with the driving motor;
a following pulley, socketed to the eccentric shaft; and
a transmission belt, wound around the driving pulley and the following pulley;
wherein a center line of rotation of some structures where the reciprocation movement unit cooperates with the eccentric shaft is non-overlapped with a center line of rotation of some structures where the following pulley cooperates with the eccentric shaft, and an inertia wheel is provided at an end of the eccentric shaft away from the following pulley.

7. The shrapnel rhythmic movement mechanism according to claim 6, wherein the reciprocation movement unit comprises:
a first reciprocation plate, connected to the eccentric shaft;
a second reciprocation plate, connected to the second frame body; and
a deformation plate, wherein an end of the deformation plate is connected to the first reciprocation plate, another end of the deformation plate is connected to the second reciprocation plate, a gap is provided between two opposite ends of the first reciprocation plate and the second reciprocation plate.

8. A rhythmic furniture, comprising a shrapnel rhythmic movement mechanism; wherein the shrapnel rhythmic movement mechanism comprises:
a first frame body;
a second frame body, wherein the second frame body and the first frame body are movable relative to each other;
a driving mechanism, wherein a power output of the driving mechanism is in transmission connection with the second frame body, the driving mechanism is configured to drive the second frame body to reciprocate relative to the first frame body; and
a shrapnel direction structure provided vertically, wherein an end of the shrapnel direction structure is connected to the first frame body, another end of the shrapnel direction structure is connected to the second frame body, the shrapnel direction structure moves following the second frame body and is elastically deformable, and the shrapnel direction structure is deformed in a same direction as a movement of the second frame body.

9. The rhythmic furniture according to claim 8, wherein an upper end of the shrapnel direction structure is connected to the first frame body, and a lower end of the shrapnel direction structure is connected to the second frame body.

10. The rhythmic furniture according to claim 8, wherein a lower end of the shrapnel direction structure is connected to the first frame body, and an upper end of the shrapnel direction structure is connected to the second frame body.

11. The rhythmic furniture according to claim 8, wherein a plurality of groups of shrapnel direction structures are provided, some groups of the plurality of groups of shrapnel direction structures are located on a side where the first frame body and the second frame body cooperate with each other, and other groups of the plurality of groups of shrapnel direction structures are located on another side where the first frame body and the second frame body cooperate with each other.

12. The rhythmic furniture according to claim 8, wherein the driving mechanism comprises:
a driving motor, provided in the first frame body;
a transmission assembly, with an end being in transmission connection with an output shaft of the driving motor; and
a reciprocation movement unit, with an end being in eccentrical transmission connection with another end of the transmission assembly and another end being connected to the second frame body.

13. The rhythmic furniture according to claim 12, wherein the transmission assembly comprises:
an eccentric shaft, rotatably provided in the first frame body, wherein the reciprocation movement unit is in transmission connection with the eccentric shaft;
a driving pulley, in transmission connection with the driving motor;
a following pulley, socketed to the eccentric shaft; and
a transmission belt, wound around the driving pulley and the following pulley;
wherein a center line of rotation of some structures where the reciprocation movement unit cooperates with the eccentric shaft is non-overlapped with a center line of rotation of some structures where the following pulley cooperates with the eccentric shaft, and an inertia wheel is provided at an end of the eccentric shaft away from the following pulley.

14. The rhythmic furniture according to claim 13, wherein the reciprocation movement unit comprises:
a first reciprocation plate, connected to the eccentric shaft;
a second reciprocation plate, connected to the second frame body; and
a deformation plate, wherein an end of the deformation plate is connected to the first reciprocation plate, another end of the deformation plate is connected to the second reciprocation plate, a gap is provided between two opposite ends of the first reciprocation plate and the second reciprocation plate.
